(19) United States
(12) Patent Application Publication
(10) Pub. No.: US 2014/0312604 A1
(43) Pub. Date: Oct. 23, 2014

(54) Mud Flap System

(71) Applicant: Hector Carrillo, Winnemucca, NV (US)

(72) Inventor: Hector Carrillo, Winnemucca, NV (US)

(21) Appl. No.: 13/868,896

(22) Filed: Apr. 23, 2013

(51) Int. Cl. B62D 25/16

(52) U.S. Cl. CPC B62D 25/163; B62D 25/168
USPC 280/851; 29/428

(57) ABSTRACT

A vehicle mud flap system is presented. This system provides the ability to allow a user a single person to replace a mud flap on a large truck such as a mining truck in approximately an hour. Currently, 3-4 people and about 3 hours are needed. The vehicle mud flap system comprises a first elongated member, a second elongated member and a third elongated member. The first elongated member is designed to install onto a vehicle. The second elongated member is connected to a mud flap. The third elongated member is connected to a base member and includes an elongated slit. The second elongated member is designed to slide into the third elongated member with the mud flap passing through the elongated slit. The third elongated member is designed to slide into the first elongated member.

### FIELD OF THE DISCLOSURE

The present disclosure relates generally to the field of mud flap systems for vehicles. More particularly, the present disclosure relates to a mud flap on a vehicle that can be easily removed from and replaced on a vehicle.

### BACKGROUND

Mud flaps are commonly used in all commercial trucks, large trailers, cars, dump trucks and heavy industrial trucks such as mining and construction trucks. The debris and mud particles stuck in the truck tires cause dangerous problems to other vehicles travelling behind or alongside these heavy trucks. If the rotating tire of a truck throws mud particles towards the windshield of a vehicle, the visibility for that vehicle becomes extremely difficult. Mud flaps are designed to protect vehicles, passengers and pedestrians from mud, water, snow and other debris thrown out by the tires of the trucks.

Various types of mud flaps are available today. These include diamond plate mud flaps, front mud flaps and rear mud flaps. Usually, the mud flaps are attached to the vehicle by means of support rods. The support rods help to easily remove and replace the mud flaps and to securely connect the mud flaps to the vehicle. These support rods are subjected to mechanical damage due to the constant bouncing of heavy trucks on the road; and the constant barrage of material expelled from the tires. This in turn deteriorates the mud flap connected to the support rods. Many attempts have been made to solve this problem.

One such solution provides a mud flap system for vehicles with a substantially L-shaped rod to carry a mud flap and a rigid bracket to receive the rod. The bracket is substantially unitary in structure and includes a vertical socket through which one leg of the L-shaped rod is inserted. However, this L-shaped rod assembly increases the complexity of the mud flap system and is very expensive.

Another method describes a retractable wheel flap-mounting assembly for dump trucks. The retractable wheel flap-mounting assembly includes a rigid supporting member fixed to the rear edge of the bottom of the dump truck body and includes a pair of flap-mounting slides mounted on the supporting member. This wheel flap-mounting assembly requires expensive modifications to the truck body for the permanent mounting of the mud flap assembly; and it cannot be easily removed and replaced.

Therefore, there is a need for a mud flap device that would be safely and easily removed from a vehicle. The needed device would be simple in construction, easy to use and cost effective. This needed device would be easily mounted on the vehicle without modifying the vehicle itself. The mud flaps on large trucks such as used in the mining industry currently require 3-4 men and about 2-3 hours to replace. And the current methods present considerable safety hazards for those men.

### SUMMARY OF PREFERRED EMBODIMENT OF THE DISCLOSURE

### Advantages of One or More Embodiments of the Present Disclosure

The various embodiments of the present invention may, but do not necessarily, achieve one or more of the following advantages:

The ability to allow a user a single person to replace a mud flap on a large truck such as a mining truck in approximately an hour. Currently, 3-4 people and about 3 hours are needed.

The ability to allow a user to easily and safely replace a mud flap from a vehicle.

The ability to provide a vehicle mud flap system to protect vehicles, passengers and pedestrians from mud and other debris thrown out by the tires of the trucks.

The ability to provide a vehicle mud flap system that is simple in construction, easy to use and cost effective.

The ability to provide a vehicle mud flap system that is mounted on a vehicle without modifying the vehicle itself.

The ability to provide a mud flap system being capable of being replaced by the use of a forklift. Currently, mud flaps must be replaced manually.

These and other advantages may be realized by reference to the remaining portions of the specification, claims, and abstract.

### BRIEF DESCRIPTION OF PREFERRED EMBODIMENT OF THE PRESENT DISCLOSURE

In the preferred embodiment, the present invention is a vehicle mud flap system for protecting vehicles, passengers and pedestrians from mud and other debris thrown out by vehicles tires. The vehicle mud flap system comprises a first elongated member, a second elongated member and a third elongated member. The first elongated member is designed to directly install onto a vehicle. The second elongated member is connected to a mud flap. The third elongated member is connected to a base member and includes an elongated slit. The three elongated members are hollow. The second elongated member connected to the mud flap is designed to slide into the third elongated member with the mud flap passing through the elongated slit. Similarly, the third elongated member is designed to slide into the first elongated member.

Each of the three elongated members includes at least one hole and at least one pin. The at least one pin is adaptable to secure the three elongated members in place by passing through the at least one hole. In the preferred embodiment, each of the three elongated members has two holes and two pins. The base member is coupled with a forklift for installing the mud flap onto the vehicle. This makes the installation of the mud flap easier.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is a perspective view of the present invention, illustrating a vehicle mud flap system installed onto a vehicle.

FIG. 2 is a front view of the present invention, illustrating a second elongated member connected to a mud flap.

FIG. 3 is a perspective view of the present invention, illustrating the second elongated member partially inserted into a third elongated member.

FIG. 4 illustrates a structural arrangement of a first elongated member, the second elongated member and the third elongated member of the vehicle mud flap system.

FIG. 5A is another embodiment of the present invention, illustrating a base member fused with the third elongated member.

FIG. 5B is yet another embodiment of the present invention, illustrating the base member connected to the third elongated member utilizing a threaded member.

FIG. 5C is an exploded view of the present invention, illustrating the threaded member.

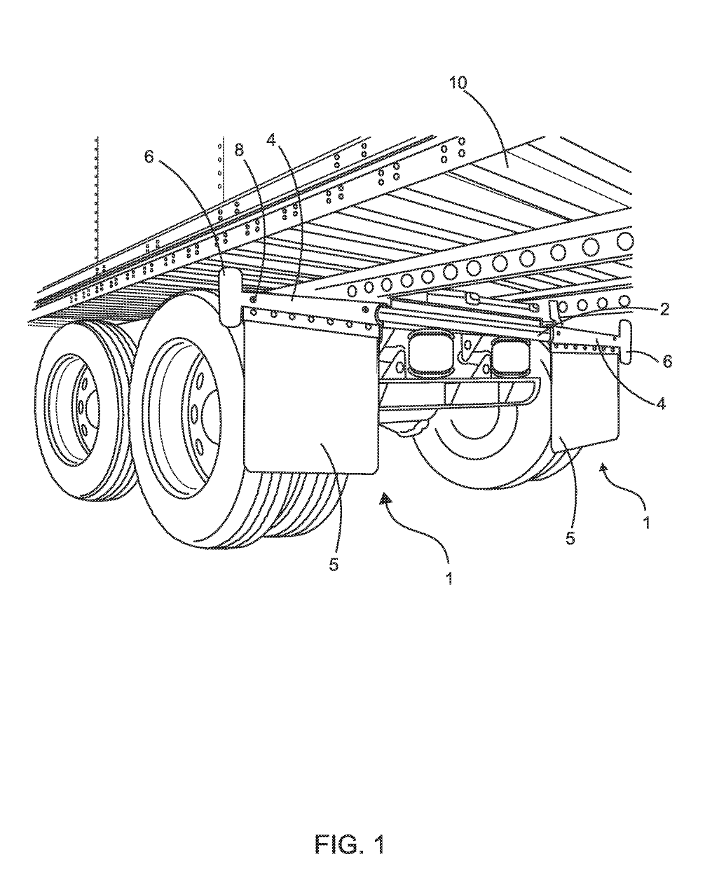

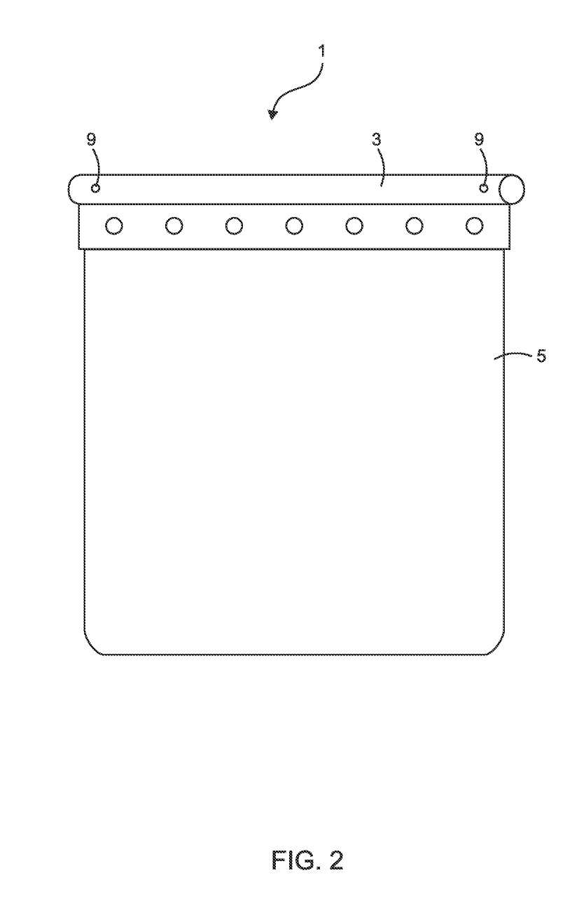

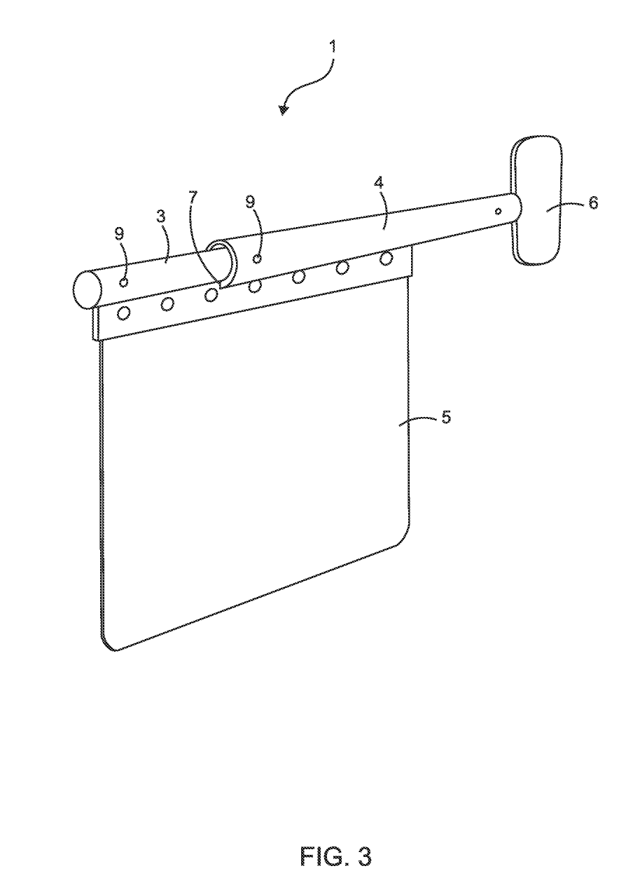

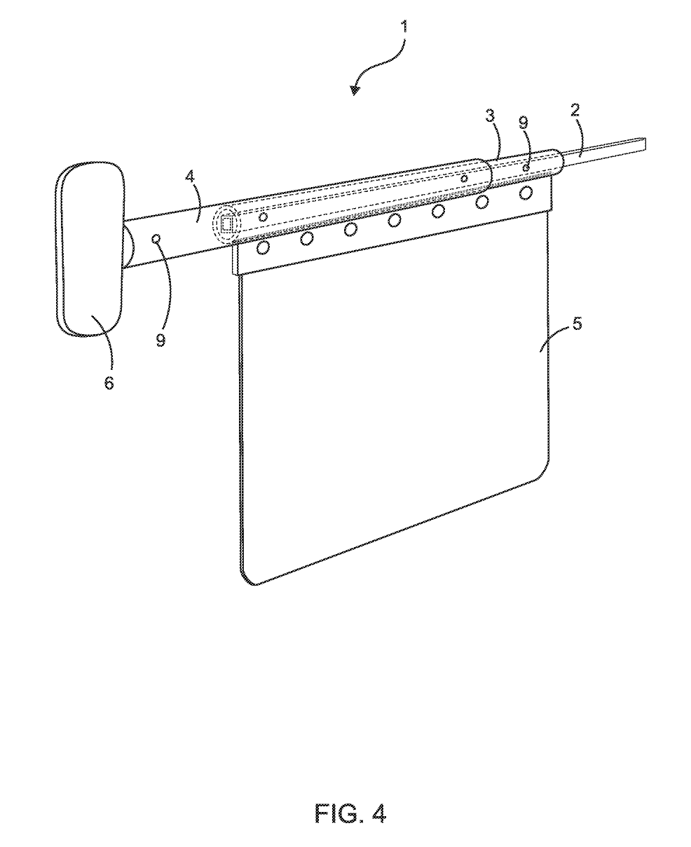

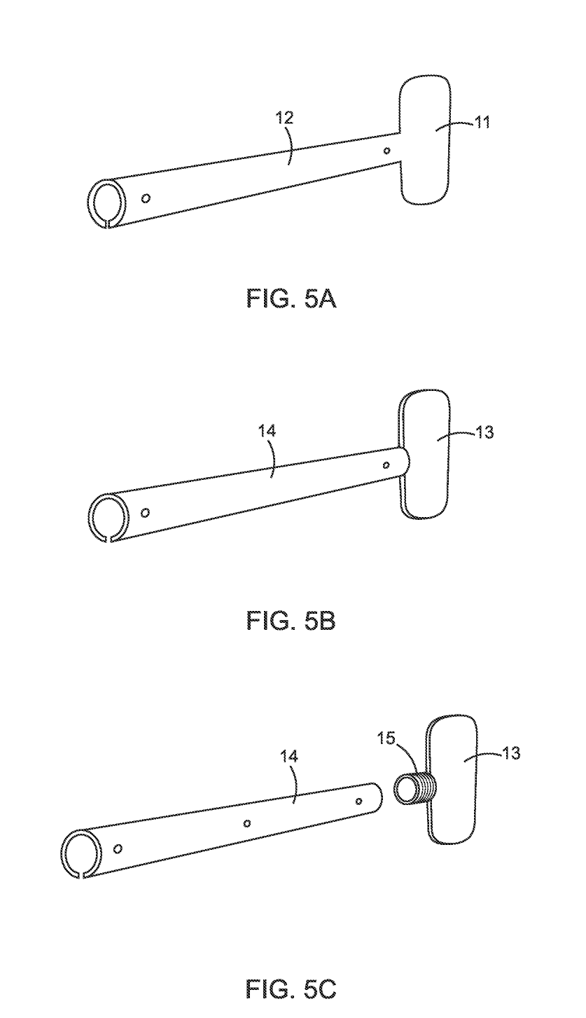

### DESCRIPTION OF CERTAIN EMBODIMENTS OF THE PRESENT DISCLOSURE

In the following detailed description of the preferred embodiment, reference is made to the accompanying drawings, which from a part of this application. The drawings show, by way of illustration, specific embodiments in which the invention may be practiced. It is to be understood that other embodiments may be utilized and structural changes may be made without departing from the scope of the present invention.

The following is a listing of the reference numbers included in the original drawings and the element that each reference number corresponds to and a brief description:
1. Vehicle mud flap system. The vehicle mud flap system 1 includes a first elongated member 2, a second elongated member 3 and a third elongated member 4 in accordance with the present invention.
2. First elongated member. This is pre-installed onto a vehicle 10.
3. Second elongated member. This is connected to a mud flap 5.
4. Third elongated member. This includes an elongated slit 7 and is connected to a base member 6.
5. Mud flap. This is connected to the second elongated member 3.
6. Base member. This is connected to the third elongated member 4 and allows attaching the mud flap 5 to a forklift.
7. Elongated slit. This allows the mud flap 5 to pass through the third elongated member 4.
8. Pin. This is used for securing the three elongated members 2, 3 and 4 in place.
9. Hole. This is located at the three elongated members 2, 3 and 4.
10. Vehicle. The vehicle mud flap system 1 is installed onto the vehicle 10.
11. A base member of another embodiment. This is designed to fuse with a third elongated member 12.
12. A third elongated member of another embodiment. This is fused with the base member 11.
13. A base member of yet another embodiment. This is detachably attached to a third elongated member 14.
14. A third elongated member of yet another embodiment. This portion is detachably attached to the base member 13.
15. A threaded member. This is utilized for detachably connecting the base member 13 to the third elongated member 14.

The present invention is a vehicle mud flap system 1 for protecting vehicles, passengers and pedestrians from mud and other debris thrown out by vehicles tires. The mud flap system 1 comprises a first elongated member 2, a second elongated member 3 and a third elongated member 4. The first elongated member 2 is pre-installed onto a vehicle 10. The second elongated member 3 is connected to a mud flap 5. The third elongated member 4 is connected to a base member 6 and includes an elongated slit 7. All the three elongated members 2, 3 and 4 are hollow. The second elongated member 3 attached to the mud flap 5 is configured to slide into the third elongated member 4 with the mud flap 5 passing though the elongated slit 7. Similarly, the third elongated member 4 is designed to slide into the first elongated member 2 pre-installed onto the vehicle 10.

The vehicle mud flap system 1 further comprises at least one pin 8 and at least one hole 9. The three elongated members 2, 3 and 4 are attached together by passing the at least one pin 8 through the at least one hole 9. In the preferred embodiment, there are two holes and two pins for each of the elongated members 2, 3 and 4.

Preferably, the mud flap 5 is very heavy. The base member 6 is designed to couple with a forklift for installing the mud flap 5 onto the vehicle 10. This eliminates the need for lifting the heavy mud flap 5 manually. Therefore, the vehicle mud flap system 1 requires less number of people to replace a mud flap 5 from the vehicle 10. The vehicle 10 may be a semi-truck, the forklift, a mining truck, a heavy industrial truck and a pickup truck. The first elongated member 2 can be installed without requiring any modification to the vehicle 10.

In use, the first elongated member 2 is installed onto the vehicle 10. Next, the mud flap 5 is connected to the second elongated member 3. Thereafter, the second elongated member 3 attached to the mud flap 5 is slid into the third elongated member 4 through the elongated slit 7. Since the third elongated member 4 is hollow, the mud flap 5 and the second elongated member 3 easily passes through the elongated slit 7. Next, the third elongated member 4 is slid into the first elongated member 2. The base member 6 is connected to the forklift for installing the mud flap system 1 onto the vehicle 10.

In another embodiment of the present invention, a base member 11 and a third elongated member 12 are fused together. In yet another embodiment of the present invention, a base member 13 includes a threaded member 15. The base member 13 is detachably attached to a third elongated member 14 utilizing the threaded member 15.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A vehicle mud flap system comprising:
a. a first elongated member installed onto a vehicle, the first elongated member being hollow;
b. an second elongated member connected to a mud flap;
c. a third elongated member connected to a base member, the third elongated member being hollow and having an elongated slit;
d. wherein:
i. the second elongated member is configured to slide into the third elongated member with the mud flap passing through the elongated slit; and
ii. the third elongated member is configured to slide into the first elongated member.

2. The system of claim 1, further comprising at least one pin configured to secure the first, second, and third elongated members in place by passing through at least one hole in each of the three elongated members.

3. The system of claim 2, having exactly two pins and exactly two holes in each of the elongated members.

4. The system of claim 1, wherein the vehicle comprises a truck.

5. The system of claim 1, wherein the vehicle is selected from the group consisting of a semi-truck, a forklift, a mining truck and pickup truck.

6. The system of claim 1, wherein the base member is coupled with a forklift such that the muds flap may be installed onto the vehicle using the forklift.

7. The system of claim 1, wherein the vehicle comprises a heavy industrial truck.

8. A method of installing a mud flap onto a vehicle comprising the steps of:
a. Installing a first elongated member onto a vehicle, the first elongated member being hollow;
b. connecting a mud flap to a second elongated member, the second elongated member being hollow;
c. sliding the second hollow elongated member into a third elongated member, the third elongated member being hollow, and having an elongated slit, such that the mud flap passes through the elongated slit;
d. sliding the third elongated member into the first elongated member.

9. The method of claim 8, wherein the third elongated member is connected to a base member.

10. The method of claim 9, further comprising coupling the base member to a forklift.
